(19) United States
(12) Patent Application Publication
(10) Pub. No.: US 2016/0189133 A1
(43) Pub. Date: Jun. 30, 2016

(54) SYSTEMS AND METHODS FOR LOCATION-BASED TRANSACTION INFORMATION CAPTURING

(71) Applicant: PayPal, Inc., San Jose, CA (US)

(72) Inventor: Anvesh Yah Vagiri, Hyderabad (IN)

(21) Appl. No.: 15/063,372

(22) Filed: Mar. 7, 2016

Related U.S. Application Data
(63) Continuation of application No. 13/939,539, filed on Jul. 11, 2013.

(51) Int. Cl. G06Q 20/32; G06Q 20/40

(52) U.S. Cl. CPC G06Q 20/3224; G06Q 20/405

(57) ABSTRACT

Systems and methods for capturing location-based transaction details are provided. The system includes a location component configured to determine a location of a user device. The system also includes one or more processors configured to determine if the determined location is a favorite location of a user of the user device or if the user has been in the location for a time period greater than a threshold time, prompt the user to enter transaction information, and receive entered transaction information. The system also includes a memory configured to store the received transaction information, and a network interface component configured to send the stored transaction information. The sent transaction information may be stored on a remote server and may be accessed by user so that a user may be capable of viewing their transaction and other account information over a network.

### CROSS REFERENCE TO RELATED APPLICATIONS

This application is a continuation of U.S. patent application Ser. No. 13/939,539 filed on Jul. 11, 2013, the full disclosure of which is incorporated by reference herein in its entirety and for all purposes.

### BACKGROUND

1. Technical Field

Embodiments disclosed herein are related to systems and methods for capturing location-based transaction information.

2. Related Art

The increased connectivity of people and their mobile devices has led to people replacing the traditional checkbook for financial account information with computing devices. Using a web browser or a specific application, a user can access their financial information from each of the financial account providers on the go and when they want. However, a user may have multiple credit card, checking, savings, and other accounts that may be handled by different financial account providers. The user likely can only access information related to a specific account from each account provider. As a result, a user may need to visit many different websites or use different applications in order to view the financial account activity of the different account providers. Moreover, a user may not be able to view or monitor their cash transaction activity from the financial account providers, which they are not able to monitor and track.

### BRIEF DESCRIPTION OF THE FIGURES

FIG. 1 is a block diagram of a networked system, consistent with some embodiments.

FIG. 2 is a diagram illustrating computing system, consistent with some embodiments.

FIGS. 3A and 3B are diagrams illustrating an example interface for capturing and viewing financial transactions, consistent with some embodiments.

FIG. 4 is a diagram providing an example of an interface for displaying financial information for scanning by financial applications, consistent with some embodiments.

FIG. 5 is a diagram illustrating a map of user transactions, consistent with some embodiments.

FIG. 6 is a flowchart illustrating a method for capturing transaction details at a location, consistent with some embodiments.

FIG. 7 is a flowchart illustrating a method for providing financial account information for review, consistent with some embodiments.

FIG. 8 is a flowchart illustrating a method for maintaining financial account information, consistent with some embodiments.

In the drawings, elements having the same designation have the same or similar functions.

### DETAILED DESCRIPTION

In the following description, specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

Consistent with some embodiments, there is provided a system for capturing transaction details. The system includes a location component configured to determine a location of a user device. The system also includes one or more processors configured to determine if the determined location is a favorite location of a user of the user device or if the user has been in the location for a time period greater than a threshold time, prompt the user to enter transaction information, and receive entered transaction information. The system also includes a memory configured to store the received transaction information, and a network interface component configured to send the stored transaction information.

Consistent with some embodiments, there is also provided a method for capturing transaction details. The method includes steps of determining a location of a user device, determining if the determined location is a favorite location of a user of the user device or if the user has been in the location for a time period greater than a threshold time, prompting the user to enter transaction information when the determined location is a favorite location of the user or if the user has been in the determined location for a time period greater than the threshold time, receiving entered transaction information, and sending the stored transaction information. The method may be embodied in computer-readable media, and may be performed by a client or user device.

Consistent with some embodiments, there is further provided a method for maintaining financial account information. The method includes steps of receiving transaction details from a user, parsing the received transaction details for transaction information, adding the transaction information to account information associated with the user, and sending account information associated with the user when the user requests the account information. The method may be embodied in computer-readable media, and may be performed by a server.

Embodiments described herein may enable a payment service provider to capture transaction details even when the user does not use the services of the payment service provider for payment for the transaction. As a result, the payment service provider may be able to obtain more comprehensive transaction information of the user, enabling the payment service provider to provide more relevant content back to the user, such as recommendations related to transactions, as well as enabling the payment provider to be able to present the user with the comprehensive transaction information and details that includes transactions performed by payment service provider and other transactions captured by the payment service provider.

These and other embodiments will be described in further detail below with respect to the following figures.

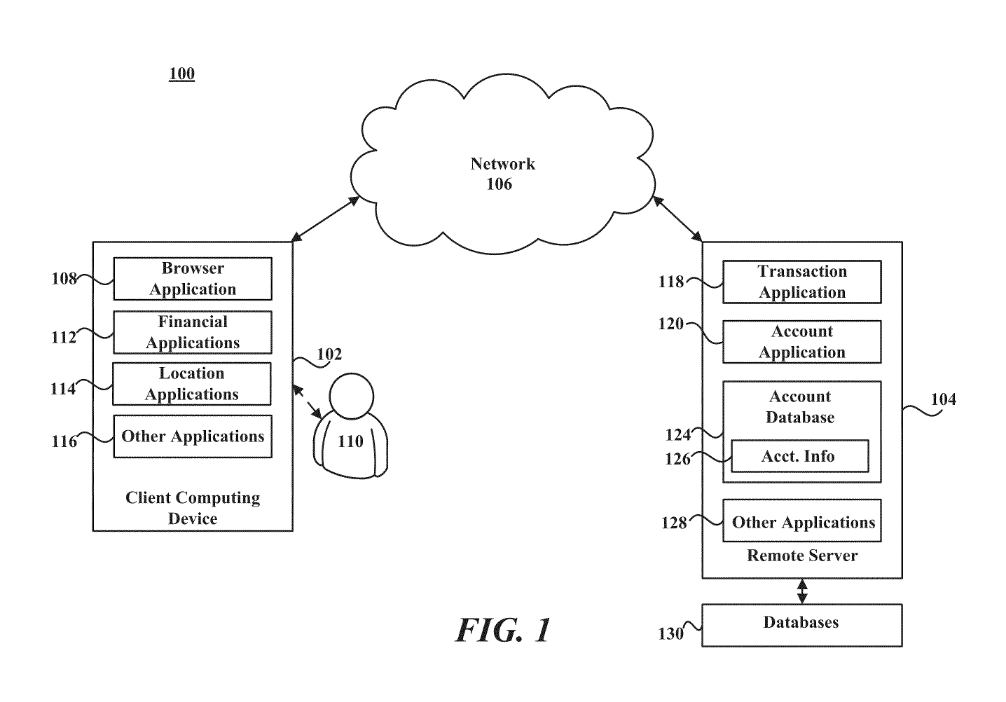

FIG. 1 is a block diagram of a networked system 100, consistent with some embodiments. System 100 includes a client computing device 102 and a remote server 104 in communication over a network 106. Remote server 104 may be a payment service provider server that may be maintained by a payment provider, such as PayPal, Inc. of San Jose, Calif. Remote server 104 may be maintained by other service providers in different embodiments. Remote server 104 may also be maintained by an entity with which sensitive credentials and information may be exchanged with client computing device 102. Remote server 104 may be more generally a web site, an online content manager, a service provider, such as a bank, or other entity who provides content to a user requiring user authentication or login.

Network 106, in one embodiment, may be implemented as a single network or a combination of multiple networks. For example, in various embodiments, network 106 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Client computing device 102, in one embodiment, may be implemented using any appropriate combination of hardware and/or software configured for wired and/or wireless communication over network 106. For example, client computing device 102 may be implemented as a wireless telephone (e.g., smart phone), tablet, personal digital assistant (PDA), notebook computer, personal computer, a connected set-top box (STB) such as provided by cable or satellite content providers, or a video game system console, a head-mounted display (HMD) or other wearable computing device, including a wearable computing device having an eyeglass projection screen, and/or various other generally known types of computing devices.

Consistent with some embodiments, client computing device 102 may include any appropriate combination of hardware and/or software having one or more processors and capable of reading instructions stored on a tangible non-transitory machine-readable medium for execution by the one or more processors. Consistent with some embodiments, client computing device 102 includes a machine-readable medium, such as a memory (not shown) that includes instructions for execution by one or more processors (not shown) for causing client computing device 102 to perform specific tasks. For example, such instructions may include browser application 108 such as a mobile browser application, which may be used to provide a user interface to permit a user 110 to browse information available over network 106. For example, browser application 108 may be implemented as a web browser to view information available over network 106. Browser application 108 may include a graphical user interface (GUI) that is configured to allow user 110 to interface and communicate with remote server 104 or other servers managed by content providers or merchants via network 106. For example, user 110 may be able to access websites to find and purchase items, as well as access user account information or web content.

Client computing device 102 may also include one or more financial applications 112. In some embodiments, financial applications 112 may be applications that allow user 110 to monitor their finances, including their account balances, their spending, and their transactions made with one or more banks or payment service processing providers, such as may be provided by PayPal, Inc. of San Jose, Calif., and implemented on remote server 104. Financial applications 112 may also allow user 110 to enter into and perform transactions over network 106, including authorizing payments to be processed by a payment service processing provider, such as may be implemented by remote server 104.

In some embodiments, financial applications 112 may provide user 110 with functionality to enter details of a transaction, including a location, merchant name, date, amount, and goods and/or services (collectively referred to as items) exchanged in the transaction. In some embodiments, financial applications 112 may prompt user to enter transaction details when a user has been at specific location for a predetermined amount of time. In some embodiments, financial applications 112 may work with location applications 114 to determine a location of client computing device 102 and user 110 using device 102, and determine if a current location is a location of a place where user 110 may conduct a financial transaction and prompt user 110 to enter details of the transaction. In some embodiments, user 110 may be able to designate certain locations as being favorites or as being places or merchants where user 110 desires to track their spending at such that when location applications 114 determines that client computing device 102 is at a designated location, financial applications 112 may prompt user 110 to enter details of any transactions that may have occurred at the designated location.

In some embodiments, financial applications 112 may be capable of scanning incoming and outgoing e-mails, short messaging service (SMS) messages and device 102 generated alerts (sometimes referred to as push alerts) for details of a transaction, and automatically enter these details. For example, when user 110 completes a transaction using client computing device, that is, when user 110 successfully exchanges a payment for items, client computing device 102 may receive a message, whether an e-mail, SMS, or push alert providing the details of the transaction. Financial applications 112 may be capable of scanning and parsing this information for capturing these details to track spending and finances. In some embodiments, financial applications 112 may request authorization from user 110 before scanning and parsing messages for details of financial transactions.

As discussed previously, location applications 114 may work with financial applications 112 to determine and monitor a location of client computing device 102 and, thus, user 110. Location applications 114 may correspond to one or more location determining applications that work with location components of client computing device 102 to determine a location of client computing device 102. In some embodiments, location applications 114 may work with a global positioning system (GPS) component of client computing device 102 to determine a location of client computing device 102. In some embodiments, location applications 114 may determine a location of client computing device 102 based on an assigned internet protocol (IP) address of client computing device 102 on network 106. Location applications 114 may also determine a location of client computing device 102 based on one or more telecommunication towers that client computing device 102 may be in communication with for connecting to network 106. Location applications 114 may further determine a location of client computing device 102 based on one or more wireless access points (WAPs) that client computing device 102 is in communication with for connecting to network.

Location applications 114 may also work with financial applications 112 so that user 110 may designate certain places and locations as being favorites, such that when location applications 114 determines that client computing device 102 is at a designated favorite location, user 110 may be prompted to enter details of transactions occurring at the designated location. Location applications 114 may also provide mapping functionality to financial applications 112. For example, financial applications 112 may display a map showing where user 110 has performed a financial transaction, and the amount. In some embodiments, user 110 may be able to interact with the displayed map to view details of the transactions at each location, and see what was purchased, the amount spent, etc. In some embodiments, the mapping functionality may be provided using one or more third party Application Programming Interfaces (APIs).

Client computing device 102 may include other applications 116 as may be desired in one or more embodiments to provide additional features available to user 110, including accessing a user account with remote server 104. For example, applications 116 may include interfaces and communication protocols that allow the user to receive and transmit information through network 106 and to remote server 104 and other online sites. Applications 116 may also include security applications for implementing client-side security features, programmatic client applications for interfacing with appropriate APIs over network 106 or various other types of generally known programs and/or applications. Applications 116 may include mobile applications downloaded and resident on client computing device 102 that enables user 110 to access content through the applications.

Remote server 104, according to some embodiments, may be maintained by an online payment provider, which may provide processing for online financial and payment transactions on behalf of user 110. Remote server 104 may include at least transaction application 118, which may be configured to interact with financial applications 112 of client computing device 102 over network 106 to receive and process transaction details that have been entered by user 110 into financial applications 112 and/or at the prompting of financial applications 112. In some embodiments, transaction application 118 may parse the received transaction details and provide the parsed details to account application 120. In some embodiments, account application 120 may be capable of maintaining one or more financial accounts on remote server 104 for user 110. The financial accounts may include payment accounts, banking accounts, credit and checking accounts, and the like. In some embodiments, account application 120 may be capable of monitoring financial accounts provided by third parties by interfacing with servers corresponding to the third party accounts over network 106, and providing information about the third party accounts to user 110 over network 106.

Remote server 104 may also include an account database 124 that includes account information 126 for users having an account on remote server 104, such as user 110. In some embodiments, account application 120 may store and retrieve financial information in account information 126 of account database 124 for users such as user 110. Such information may include transaction details, such as parsed by transaction application 118 based on details provided by user 110 over network 106 using financial applications 112. Such information may also include location details that may be provided along with transaction details over network 110 from client computing device 102. In some embodiments, user 110, using browser app 108 and/or financial applications 112 may access account information 126 by interfacing with account application 120 of remote server 104 over network 106. User 110 may be able to see account details, including transaction details. User 110, using financial applications 112 and location applications 114 may also be able to create maps showing transaction details, such as described previously, by accessing and retrieving account information 126 by interacting with account application 120 of network 106.

Remote server 104 may include other applications, such as may be provided for authenticating users to remote server 104, for performing financial transactions, and for processing payments. Remote server 104 may also be in communication with one or more external databases 130, that may provide additional information that may be used by remote server 104. In some embodiments, databases 130 may be databases maintained by third parties, and may include third party financial information of user 110, such as described previously.

Although discussion has been made of applications and applications on client computing device 102 and remote server 104, applications 108-120 and 128 may also be, in some embodiments, modules. Module, as used herein, may refer to a software module that performs a function when executed by one or more processors or Application Specific Integrated Circuit (ASIC) or other circuit having memory and at least one processor for executing instructions to perform a function, such as the functions described as being performed by applications 108-120 and 128.

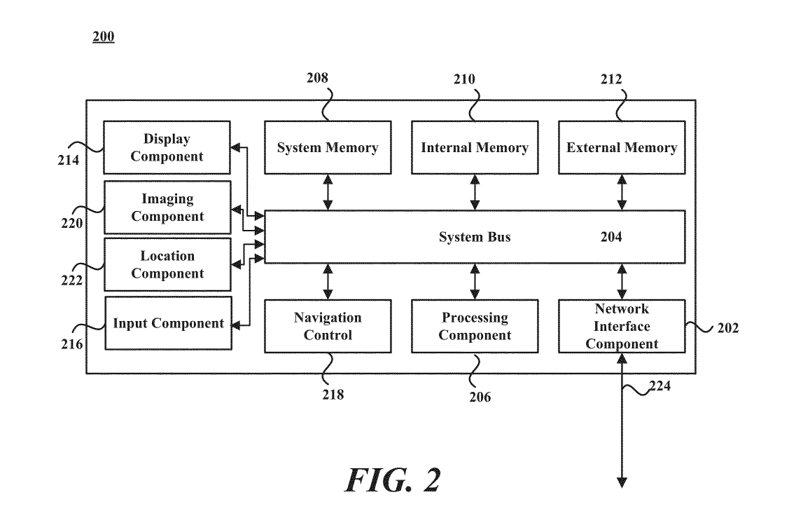

FIG. 2 is a diagram illustrating computing system 200, which may correspond to either or both of client computing device 102 or remote server 104, consistent with some embodiments. Computing system 200 may be a mobile device such as a smartphone, a tablet computer, a laptop or netbook, and the like, as would be consistent with client computing device 102. Computing system 200 may also be a personal computer, a set-top box (STB) such as provided by cable or satellite content providers, a video game system console, or a smart or internet-enabled television, as also may be consistent with client computing device 102. Computing system 200 may also be a head-mounted display (HMD) or other wearable computing device. Further, computing system 200 may also be a server or one server amongst a plurality of servers, as may be consistent with remote server 104. As shown in FIG. 2, computing system 200 includes a network interface component (NIC) 202 configured for communication with a network such as network 106 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), near field communication (NFC), and/or infrared (IR) components configured for communication with network 106. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 106.

Consistent with some embodiments, computing system 200 includes a system bus 204 for interconnecting various components within computing system 200 and communication information between the various components. Such components include a processing component 206, which may be one or more processors, micro-controllers, or digital signal processors (DSP), graphics processing units (GPUs), a system memory component 208, which may correspond to random access memory (RAM), an internal memory component 210, which may correspond to read-only memory (ROM), and an external or static memory 212, which may correspond to optical, magnetic, or solid-state memories. Consistent with some embodiments, computing system 200 further includes a display component 214 for displaying information to a user 110 of computing system 200. Display component 214 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 216, allowing for user 110 of computing system 200 to input information to computing system 200. Such information could include payment information such as an amount required to complete a transaction, account information, authentication information, or identification information. An input component 216 may include, for example, a keyboard or key pad, whether physical or virtual. Computing system 200 may further include a navigation control component 218, configured to allow a user to navigate along display component 214. Consistent with some embodiments, navigation control component 218 may be a mouse, a trackball, or other such device. Moreover, if device 200 includes a touch screen, display component 214, input component 216, and navigation control 218 may be a single integrated component, such as a capacitive sensor-based touch screen or other touch screen.

Computing system 200 may include an imaging component 220. Imaging component 220 may be any mechanism that allows for the capture of one or more images. For example, imaging component 220 may be a visible light camera. Computing system 200 may further include a location component 222 for determining a location of computing system 200. In some embodiments, location component 222 may correspond to a GPS transceiver that is in communication with one or more GPS satellites. In other embodiments, location component 222 may be configured to determine a location of computing system 200 by using an IP address lookup, or by triangulating a position based on nearby telecommunications towers or WAPs. Location component 222 may be further configured to store a user-defined location in any of system memory 208, internal memory 210, and/or external memory 212 that can be transmitted to a third party for the purpose of identifying a location of computing system 200.

Computing system 200 may perform specific operations by processing component 206 executing one or more sequences of instructions contained in system memory component 208, internal memory component 210, and/or external or static memory 212. In other embodiments, hard-wired circuitry may be used in place of or in combination with software instructions to implement the present disclosure. Logic may be encoded in a computer readable medium, which may refer to any medium that participates in providing instructions to processing component 206 for execution. Such a medium may take many forms, including but not limited to, non-volatile media, volatile media, and transmission media. The medium may correspond to any of system memory 208, internal memory 210 and/or external or static memory 212. Consistent with some embodiments, the computer readable medium is non-transitory. In various implementations, non-volatile media include optical or magnetic disks, volatile media includes dynamic memory, and transmission media includes coaxial cables, copper wire, and fiber optics, including wires that comprise system bus 204. According to some embodiments, transmission media may take the form of acoustic or light waves, such as those generated during radio wave and infrared data communications. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 224 to network 106 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 224 and network interface component 202. Communication link 224 may be wireless through a wireless data protocol such as Wi-Fi™, 3G, 4G, HSDPA, LTE, RF, NFC, or through a wired connection. Network interface component 202 may include an antenna, either separate or integrated, to enable transmission and reception via communication link 224. Received program code may be executed by processing component 206 as received and/or stored in memory 208, 210, or 212.

Computing system 200 may include more or less components than shown in FIG. 2 according to some embodiments. Moreover, components shown in FIG. 2 may be directly coupled to one or more other components in FIG. 2, eliminating a need for system bus 204. Furthermore, components shown in FIG. 2 may be shown as being part of a unitary system 200, but may also be part of a system where the components are separate but coupled and in communication. In general, the components shown in FIG. 2 are shown as examples of components in a computing system 200 capable of performing embodiments disclosed herein. However, a processing system 200 may have more or fewer components and still be capable of performing some embodiments disclosed herein.

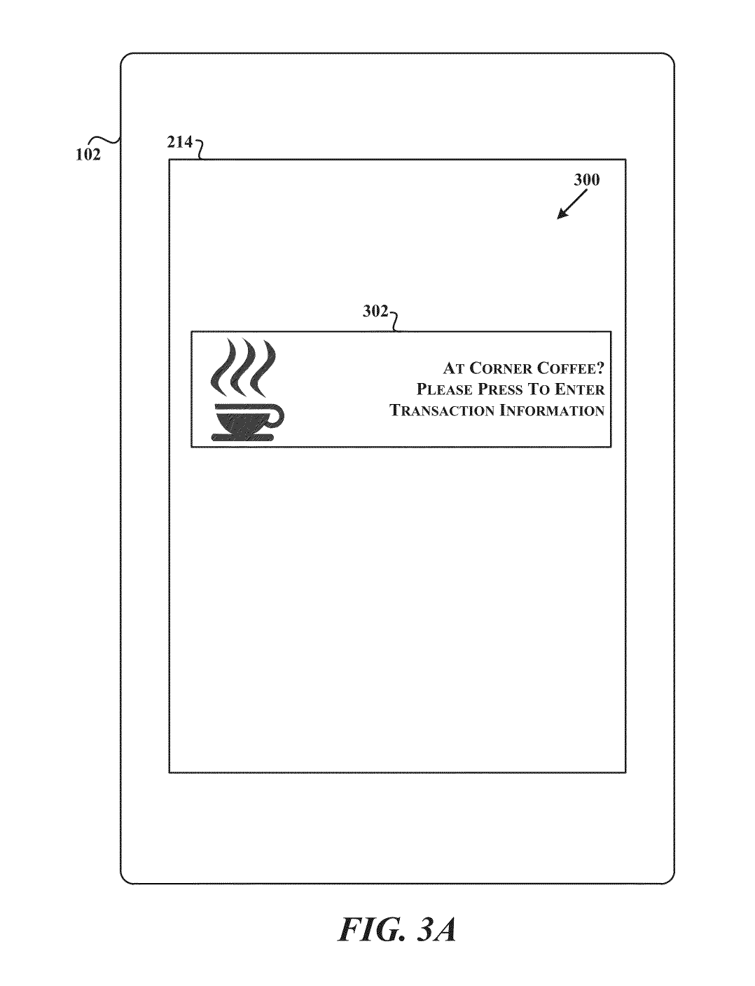

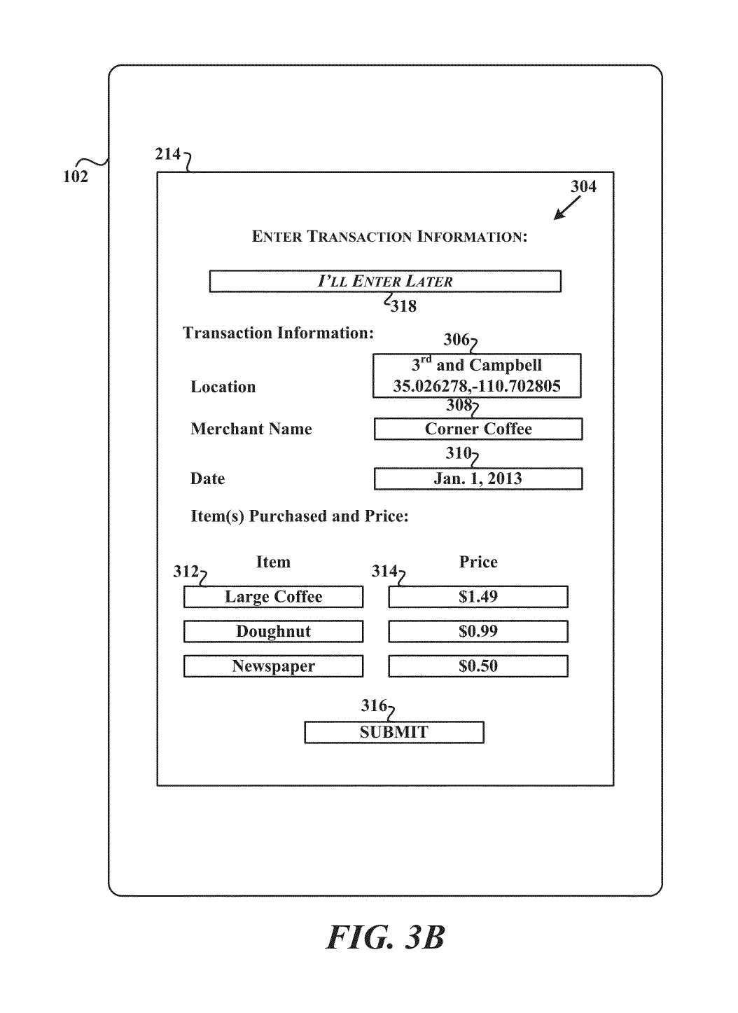

FIGS. 3A and 3B are diagrams illustrating an example interface for capturing and viewing financial transactions, consistent with some embodiments. As shown in FIG. 3A, display component 214 of client computing device 102 may display an interface 300 that displays a prompt 302 prompting user 110 to enter details of a transaction. In some embodiments, prompt 302 may be a system alert or push notification generated by processing component 206 of client computing device 102. In some embodiments, prompt 302 may be displayed by financial applications 112 based on a location of client computing device 102 and user 110 determined using location applications 114. For example, location applications 114 may determine a location of client computing device 102 based on data received from location component 222 of client computing device 102 and, if the determine location matches a favorite location designated by user 110, display prompt 302 in interface 300. In some embodiments, favorite locations may be determined by location applications 114 and/or financial applications 112 based on user 110 repeatedly going to a particular location, or checking into a location multiple times through social networking platforms or the PayPal Check In platform. Prompt 302 may include a user-selectable option for entering the transaction information at a later time.

As another example, location applications 114 working with financial applications 112 may determine a period of time in which client computing device 102 and user 110 is in the same location and, if the determined period of time is greater than a threshold period of time, financial applications may display prompt 302. The threshold period of time may be pre-set and/or may be adjustable by user 110. In some embodiments, the threshold period of time may be between five minutes and thirty minutes. In some embodiments, the threshold period of time may be between fifteen and twenty minutes. In other embodiments, the threshold period may depend on the user location. For example, if the user is at a location where the user has shopped previously, the threshold period may be shorter than when the user is at a location with no transaction history by the user. Even for locations with a transaction history, the threshold may vary, depending on factors such as how quickly the user typically performs a transaction at the location, e.g., the user may make a transaction in a much shorter time at a convenience store as opposed to a large department store. In that case, when the user is at a convenience store, the threshold period may be shorter than when the user is at a department store.

Location applications 114 may also work with third party APIs to determine information about a current location, such as the name of the business and type of business that client computing device 102 and user 110 is currently at. As shown in FIG. 3A, when client computing device 102 and user 110 are determined to be at a favorite location or determined to be at a location for a period of time greater than a threshold period of time, financial applications 112 may display prompt 302 requesting user 110 to enter transaction information. When user 110 interacts with the prompt or otherwise activates financial applications 112 to enter transaction information, user 110 may then enter the details of any transactions that user has performed at the current location. In some embodiments, user 110 may be able to enter a home location, a work location or other location such that financial applications 112 may not display prompt 302 when user 110 is at one of these entered locations for a period of time greater than a threshold period of time.

FIG. 3B illustrates an example interface 304 for entering details of a transaction, consistent with some embodiments. As shown in FIG. 3B, interface 304 may include form-fillable fields for location 306, a merchant name 308, a date of the transaction 310, and fields for each item 312 purchased and a price 314. Additional or fewer fields may be included in interface 304 in some embodiments. Moreover, one or more of the fields may be automatically filled by financial applications 112 based on information from location applications 114. For example, GPS information, such as latitude and longitude coordinates may be automatically entered in to location field 306. A merchant name 308 may also automatically be entered if the location is a designated favorite, or based on information about the location from location applications 114 and/or third party APIs. The date of the transaction 310 may also be automatically filled based on a current date as stored in a memory 208-212 of client computing device 102. For fields that are not automatically populated, user 110 may be able to enter the transaction information using input component 216 and/or navigation control 218 of client computing device 102. Other information, such as reviews of the merchant or location, tips, and the like may be entered by user 110, and this information may be associated with the merchant or location by location apps 114 alone or working with third party social APIs such that they are viewable by other users.

In some embodiments, user 110 may be capable of entering transaction information by capturing one or more images of a receipt, bill of sale, or other document referencing the transaction using imaging component 220. The one or more images of the receipt, bill of sale, or other document may be scanned for transaction information by optical character recognition (OCR) that may be performed on the one or more images by financial applications 112. In some embodiments, financial applications 112 may send the one or more captured images to remote server 104, wherein transaction application 118 may perform OCR algorithms on the received one or more images to parse transaction information.

Once user 110 has entered the information and is ready to post the information, user 110 may select the submit button 316. In some embodiments, when user 110 selects the submit button 316, financial applications 112 may place the transaction information into one or more packets such that network interface component 202 of client computing device sends the one or more packets to remote server 104 over network 106. Remote server 104 may then receive the one or more packets on a network interface component 202 of remote server 104 where transaction application 118 may parse the information for the transaction details, which may be provided to account application 120 for updating an account of user 110 and storing the transaction details in account information 126 of user 110 of account database 124. User 110 may then review the details of that transaction, and other transactions through financial applications 112 which may retrieve account information 126 of user 110 through account application 120 of remote server 104 over network 106. Financial applications 112 may then render the details of that transaction and other transactions for display on display component 214 of client computing device 102.

Interface 304 may also include an option for user to enter transaction details at a later time 318. In some embodiments, selecting the option to enter transaction details later 318 may generate a reminder prompt or push notification 302 to enter transaction details at a predetermined amount of time following the selection of option 318, such as twenty minutes, and hour, two hours, etc. In some embodiments, user 110 may select option 318 for all transactions performed during a day such that financial applications 112 may generate a prompt or push notification 302 at the end of the day for user to enter all transaction details. In some embodiments, selecting option 318 may place prompt or notification 302 in a queue, which may display all prompts or notifications 302 for various transactions and user 110 can select the queued prompts 302 at a time that is convenient to enter the transaction details. In some embodiments, option 318 may be instead displayed on prompt 302.

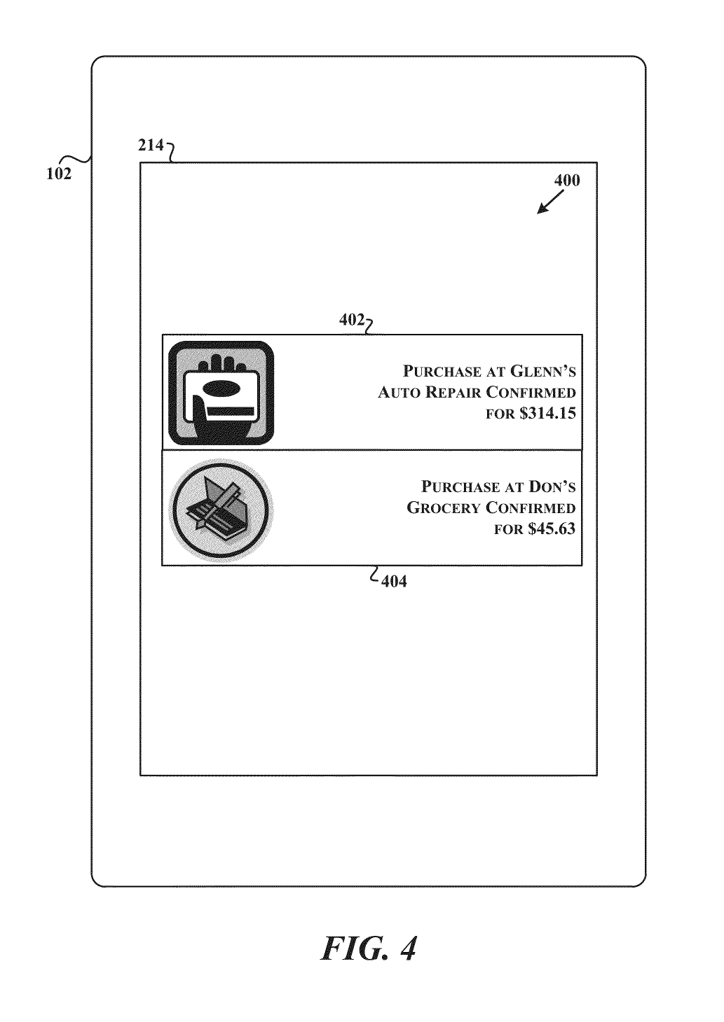

FIG. 4 is a diagram providing an example of an interface 400 for displaying financial information for scanning by financial applications 112, consistent with some embodiments. As discussed previously, financial applications 112 may be capable of scanning incoming and outgoing e-mails, short messaging service (SMS) messages and device 102 generated push alerts transaction details and automatically scan and enter these details. For example, when user 110 completes a transaction client computing device 102 may receive a message, whether an e-mail, SMS, or push alert providing the details of the transaction. As shown in FIG. 4, user 110 has received messages or alerts 402 and 404 that provide details of completed transactions. In some embodiments, messages or alerts 402 and 404 may be a received e-mail received from a merchant, payment service processing server, or financial institution detailing the completed transaction. In some embodiments, messages or alerts 402 and 404 may be SMS messages received from a merchant, payment service processing server, or financial institution detailing the completed transaction. In some embodiments, messages or alerts 402 and 404 may be push alerts generated by financial applications 112 such as may be provided by a merchant, payment service processing server, or financial institution detailing the completed transaction based on the details of the transaction being posted to the merchant, payment service processing server, or financial institution.

As an example, FIG. 4 shows that alert or message 402 provides details of a credit card transaction made at Glenn's Auto Repair for $314.15 and that alert or message 404 provides details of a check that was cashed by Don's Grocery in the amount of $45.63. In some embodiments, messages or alerts 402 and 404 may include more or less details, including a location of the merchant a date of the transaction, and individual items making up the transaction, if applicable. In some embodiments, location applications 114 may determine the location of the merchants based on locations stored in memories 208-212 of client computing device 102 if user 110 has visited the merchant previously, designated the merchant as a favorite location, or entered transaction information for the merchant previously. In some embodiments, location applications 114 may determine a location of the merchants using third party information, such as may be provided by one or more third party APIs. Financial applications 112 may be capable of automatically scanning and parsing information provided in messages or alerts 402 and 404 for capturing transaction details. Financial applications 112 may then place the transaction information into one or more packets such that network interface component 202 of client computing device sends the one or more packets to remote server 104 over network 106. Remote server 104 may then receive the one or more packets on a network interface component 202 of remote server 104 where transaction application 118 may parse the information for the transaction details, which may be provided to account application 120 for updating an account of user 110 and storing the transaction details in account information 126 of user 110 of account database 124.

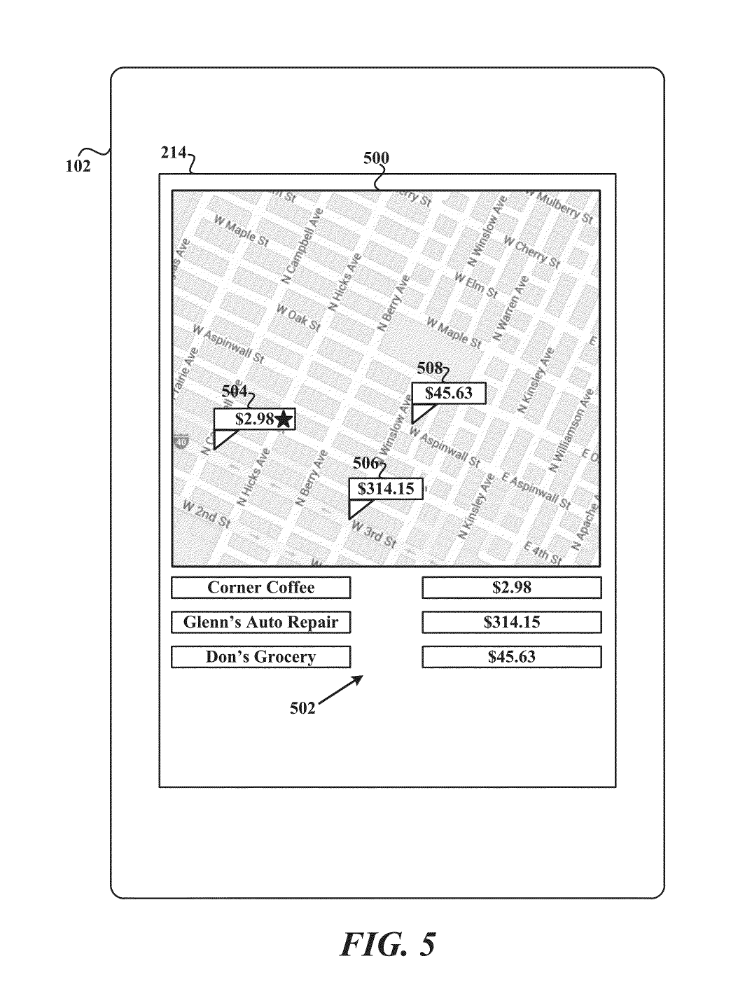

FIG. 5 is a diagram illustrating a map 500 of user transactions, consistent with some embodiments. User 110 may interact with financial applications 112 for reviewing and viewing details of transactions that have been provided to remote server 104. For example, user 110 may be able to use financial applications 112 to view map 500 of transactions as well as a listing 502 of transactions, with information regarding the transactions being provided from account application 120 of remote server 104. As shown in FIG. 5, map 500 includes markers 504, 506, and 508 that illustrate locations where user 110 has performed a transaction based on transaction details that have been provided to remote server 104. For example, marker 504 shows the total amount of the transaction that user 110 conducted at Corner Coffee (shown in FIGS. 3A and 3B), marker 506 shows the total amount of the transaction conducted at Glenn's Auto Repair (shown in FIG. 4), and marker 508 shows the total amount of the transaction conducted at Don's Grocery (shown in FIG. 4). In some embodiments, selecting markers 504-508 may display additional details of the transaction. In some embodiments, markers 504-508 may display additional details of the transaction. Moreover, markers 504-508 may display an indication that the location is a designated favorite, such as shown by marker 504 which includes a star indicating that Corner Coffee is a favorite location. User 110 may also be able to select elements in listing 502 for additional information. For example, when user 110 selects either the field for “Corner Coffee” or “$2.98” from listing 502, user may be presented with an itemized listing of the items purchased, such as shown in FIG. 3B. User 110 may further be able to view past purchases at the merchant or location.

Map 500 may have additional functionality as may be provided by location applications 114 and/or third party APIs. In some embodiments, user 110 may be capable of interacting with map 500 to display different areas and zoom in and out. In some embodiments, when user 110 zooms out, the details of transactions may be combined to show details for neighborhoods, cities, and the like. For example, if user 110 interacts with map 500 to zoom out of the area currently displayed, user 110 may be presented with a marker that shows a total of $362.76 which is the total amount from transactions in the displayed area.

Map 500 may also have social capabilities such as may be provided by location applications 114 alone or in combination with third party APIs provided by social platforms. For example, map 500 may be capable of displaying friends of user 110 and locations where friends of user 500 have recently performed transactions, or where the friends currently are located. Map 500 may also be capable of displaying additional social information, such as reviews, tips, and the like of merchants and locations as entered by user 110 and others who have visited the location or merchant.

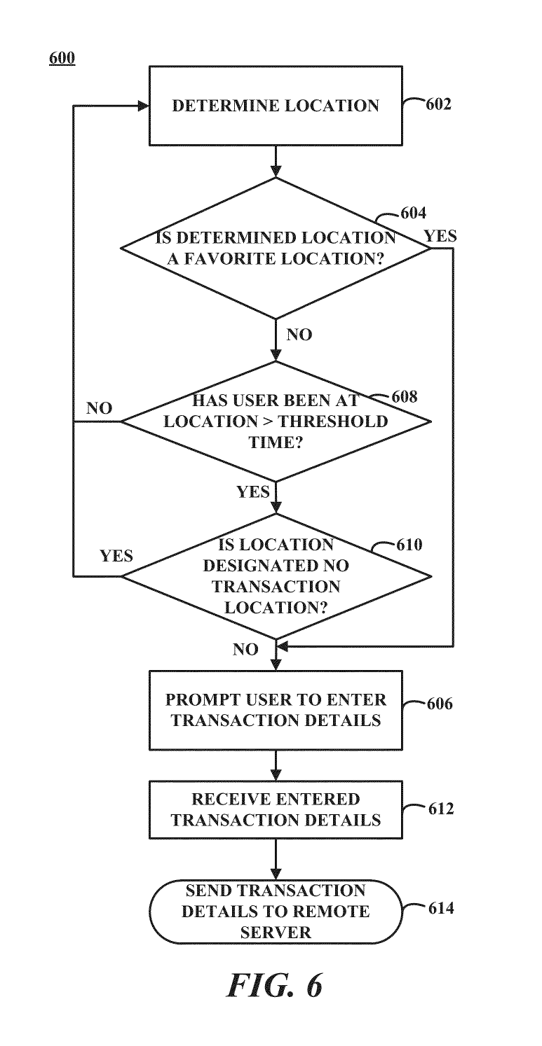

FIG. 6 is a flowchart illustrating a method 600 for capturing transaction details at a location, consistent with some embodiments. For the purpose of illustration, FIG. 6 may be described with reference to any of FIGS. 1, 2, 3A, 3B, 4, and 5. Method 600 shown in FIG. 6 may be embodied in computer-readable instructions for execution by one or more processors in processing component 206 such that the steps of the method may be performed by client computing device 102. As shown in FIG. 6, method 600 begins by determining a location of client computing device 102 (602). In some embodiments, it may be assumed that user 110 is carrying client computing device 102 and, thus, a location of client computing device 102 may also be a location of user 110. In some embodiments, location of client computing device 102 and user 110 may be determined by location applications 114 using location component 220. When the determined location is determined to be a designated favorite location (604) user may be prompted to enter transaction details (606). For example, financial applications 112 may display interface 300 having prompt 302 to user 110.

When the determined location is not determined to be a designated favorite location, processing component 206 may monitor a time that client computing device 102 and user 110 is at the same location. When the user is determined to be at the location for a period of time greater than a threshold time (608), a determination may be made to determine if the determined location is a designated no transaction location (610). In some embodiments, a designated no transaction location may be a home or work location designated by user 110 as a location where user 110 is not likely to enter into any transactions. If the determined location is determined not to be a designated no transaction location, user may be prompted to enter transaction details (606). For example, processing component 206 of client computing device 102 may execute instructions provided by financial applications 112 may displaying interface 300 having prompt 302 to user 110 on display component 214 of client computing device 102. When financial applications 112 has received transaction information details (612) financial applications 112 may provide instructions for sending the transaction details to remote server 104 (614). In some embodiments, user 110 may enter transaction information details in interface 304. In some embodiments, network interface component 202 of client computing device 102 may send the transaction information details based on instructions from financial applications 112 executed by processing component 206. Although not shown in FIG. 6, financial applications 112 may receive transaction details by automatically scanning messages or alerts, such as messages or alerts 402 and 404 shown in FIG. 4. Embodiments consistent with method 600 may prompt or otherwise remind user 110 to enter transaction information that is not already processed or handled by remote server 104 to be sent to and stored by remote server 104 so that user 110 may be able to review their financial information from remote server 104. Moreover, method 600 may allow user 110 to monitor their transaction activity that is handled by cash, since such activity is typically difficult to track and monitor.

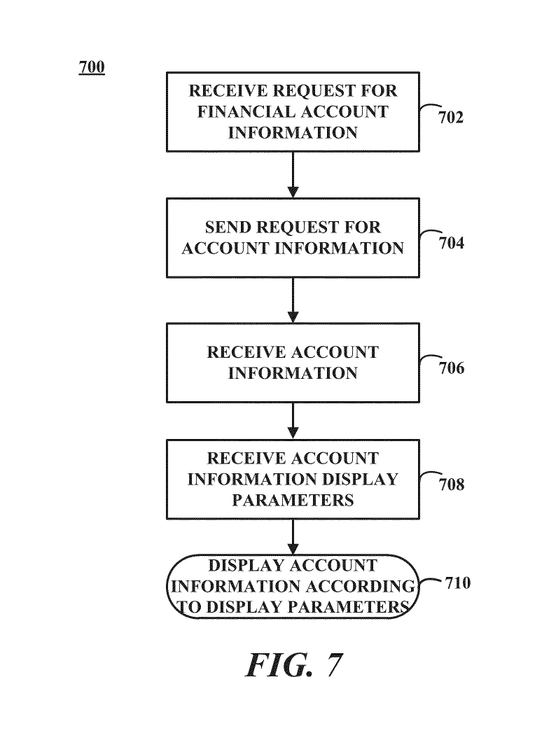

FIG. 7 is a flowchart illustrating a method for providing financial account information for review, consistent with some embodiments. For the purpose of illustration, FIG. 7 may be described with reference to any of FIGS. 1, 2, 3A, 3B, 4, and 5. The method shown in FIG. 7 may be embodied in computer-readable instructions for execution by one or more processors in processing component 206 such that the steps of the method may be performed by remote server 104. As shown in FIG. 7, method 700 begins when financial applications 112 receive a request for financial account information (702). User 110 may interact with input component 216 and/or navigation control 218 of client computer device 102 to instruct processing component 206 to execute financial applications 112 and request financial account information. A request for account information may then be sent to remote server 104 (704). In some embodiments, processing component 206 executing financial applications 112 may instruct network interface component 202 of client computing device 102 to send a request for account information from remote server 104.

The requested account information may then be received (706). In some embodiments, network interface component 202 of client computing device 102 may receive the requested account information from remote server 104 over network 106. Parameters for account information may be received (708). In some embodiments, user 110 may interact with financial applications 112 using input component 216 and navigation component 218 to select how user 110 wants the received account information to be displayed on display component 214 of client computing device 102. For example, user 110 may want the account information to be displayed as a map, such as map 500 shown in FIG. 5. In some embodiments, user 110 may prefer the received account information to be displayed as a graph, chart, or listing. In some embodiments, step 708 may be performed at the same time as step 702. The received account information may then be displayed according to the received display parameters (710). In some embodiments, display component 214 may receive instructions to display account information such as recent transactions as a map, such as map 500 shown in FIG. 5. Embodiments consistent with method 700 may allow user 110 to view and monitor account information in various formats, with the account information being stored centrally by remote server 104. Consequently, user 110 may be able to view and monitor the account information from any location where client computing device 102 is in communication with remote server 104 over network 106.

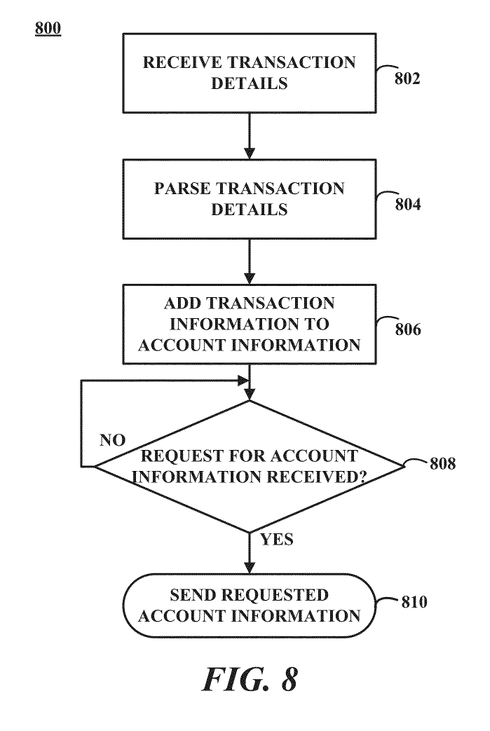

FIG. 8 is a flowchart illustrating a method for maintaining financial account information, consistent with some embodiments. For the purpose of illustration, FIG. 8 may be described with reference to any of FIGS. 1, 2, 3A, 3B, 4, and 5. The method shown in FIG. 8 may be embodied in computer-readable instructions for execution by one or more processors in processing component 206 such that the steps of the method may be performed by remote server 104. As shown in FIG. 8, method 800 begins when remote server 104 receives transaction details (802). In some embodiments, network interface component 202 of remote server 104 may receive transaction details over network 106. In some embodiments, the received transaction details may be received from client computing device 102 based on captured or entered transaction details. The received transaction details may then be parsed by remote server 104 (806). In some embodiments, transaction application 118 of remote server 106 may provide instructions for execution by processing component for the parsing of the received transaction details to identify relevant transaction information and format the identified relevant transaction information for storage and use by remote server 104. The transaction details may then be added to account information 126 (806). In some embodiments, account application 120 may provide instructions for execution by processing component 206 of remote server 104 to store the transaction details in account information 126 associated with user 126.

When remote server 104 receives a request from client computing device 102 for account information (808), the requested account information may then be sent to client computing device 102 over network 104 (810). In some embodiments, account application 120 of remote server 104 may provide instructions for execution by processing component 206 of remote server 104 for the handling and processing of requests for account information. Account information 126 associated with a user 110 making the request may then be sent by network interface component 202 over network 106. In some embodiments, user 110 may be required to authenticate with remote server 104 before account information will be sent. Embodiments consistent with method 800 may allow remote server 104 to receive and store information about transactions made by user 110 such that remote server 104 can act as a one-stop shop for the financial monitoring and information needs of user 110.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Consequently, embodiments as described herein may prompt or otherwise remind users to enter transaction information that is not already processed or handled by a remote server including cash activity to be sent to and stored by the remote server so that user may be able to store and review their financial information on the remote server. Consequently, the user may be able to view and monitor the account information from any location where they are in communication with the remote server and the remote server may be a one-stop shop for the financial monitoring and information needs of the user. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A system for capturing transaction details, comprising:
a non-transitory memory storing instructions; and
one or more hardware processors coupled to the non-transitory memory and configured to read the instructions to cause the system to perform operations comprising:
receiving location information from a location component configured to determine a location of the user device;
determining, based on the location information, whether the user device has been in the location for a time period greater than a threshold time;
determining, based on the location information, whether the user device is in a no-transaction location;
determining, based on the location information, merchant information associated with the location;
in response to determining that the user device has been in the location for a time period greater than the threshold time and that the user device is not in a no-transaction location, generating a push notification that activates a financial application at the user device to cause display of a prompt to enter details of a previously completed physical cash transaction on a user interface of the user device, wherein the prompt contains at least one data field that is automatically populated based on the determined merchant information.

2. The system of claim 1, wherein the location component is further configured to determine a global positioning system (GPS) location of the user device.

3. The system of claim 1, wherein the operations further comprise:
receiving a selection of an option to enter the details of the physical cash transaction at a later time; and
generating a second prompt to enter details of a physical cash transaction, wherein the prompt contains at least one data field that is automatically populated based on the merchant information; and
displaying the second prompt on the user device at the later time.

4. The system of claim 1, wherein the operations further comprise examining received messages and alerts for transaction information.

5. The system of claim 1, further comprising a display component, the display component configured to display an interface for entering the details of a physical cash transaction.

6. The system of claim 5, wherein:
the operations further comprise receiving a request for financial account information and account information display parameters and sending a request for the requested financial account information and receive the requested financial account information; and
the display component is configured to display the requested financial account information according to the display parameters.

7. The system of claim 6, wherein the requested financial account information comprises the sent details of the physical cash transaction.

8. The system of claim 6, wherein the display component is further configured to display the requested financial account information on a map showing locations of transactions and information associated with the transactions.

9. A method for monitoring cash transaction activity, comprising:
receiving, by a user device, location information from a location component configured to determine a location of the user device;
determining, by the user device and based on the location information, whether the user device has been in the location for a time period greater than a threshold time;
determining, by the user device and based on the location information, whether the user device is in a no-transaction location;
determining, by the user device and based on the location information, merchant information associated with the location;
generating, by the user device, a prompt to enter details of a physical cash transaction, wherein the prompt contains at least one data field that is automatically populated based on the merchant information; and
in response to determining that the user device has been in the location for a time period greater than the threshold time and that the user device is not in a no-transaction location, generating a push notification that activates a financial application at the user device to cause display of a prompt to enter details of a previously completed physical cash transaction on a user interface of the user device, wherein the prompt contains at least one data field that is automatically populated based on the determined merchant information.

10. The method of claim 9, wherein the location component is further configured to determine a global positioning system (GPS) location of the user device.

11. The method of claim 9, further comprising:
receiving a selection of an option to enter the details of the physical cash transaction at a later time; and
queuing a second prompt to enter the details of the physical cash transaction to be displayed at the later time.

12. The method of claim 9, further comprising examining, by the user device, received messages and alerts for transaction information.

13. The method of claim 9, wherein the prompt comprises an interface for entering the details of the physical cash transaction.

14. The method of claim 9, further comprising:
receiving, by the user device, a request for financial account information;
receiving, by the user device, account information display parameters;
sending, by the user device, a request for the requested financial account information;
receiving, by the user device, the requested financial account information; and
displaying, by the user device, the requested financial account information according to the display parameters.

15. The method of claim 14, wherein displaying the requested financial account information comprises displaying the sent details of the physical cash transaction.

16. The method of claim 14, wherein displaying the requested financial account information comprises displaying the requested financial account information on a map showing locations of transactions and information associated with the transactions.

17. A method for monitoring cash transaction activity, comprising:
receiving, by a server, details of a physical cash transaction from a user device, the details of the physical cash transaction having been entered by a user of the user device in response to a prompt displayed to the user when the user has been in a location for a time period greater than a threshold time and the location is not a designated no-transaction location, wherein the prompt is a push notification that activates a financial application to cause the prompt to display on the user device and to enable connection over a network to the server when the user device comes online;
parsing, by the server, the received details of the physical cash transaction for transaction information;
adding, by the server, the transaction information to account information associated with the user; and
sending, by the server, the account information associated with the user when the user requests the account information.

18. The method of claim 17, wherein the details of the physical cash transaction comprise at least one of an amount of the physical cash transaction, the merchant at which the physical cash transaction was performed, a location of the physical cash transaction, and a date of the physical cash transaction.

19. The method of claim 17, wherein sending account information comprises sending the added transaction information and other transaction information performed by the server.

20. The method of claim 17, wherein receiving details of the physical cash transaction from the user device and sending account information comprises:
receiving, by the server, a request by the user to authenticate the user with the server; and
granting, by the server, the request by the user to authenticate the user with the server.
